(19) United States
(12) Patent Application Publication
(10) Pub. No.: US 2011/0242120 A1
(43) Pub. Date: Oct. 6, 2011

(54) DISPLAY APPARATUS AND DRIVIING DEVICE FOR DISPLAYING

(75) Inventors: Akihito AKAI, Kawasaki (JP); Yoshiki Kurokawa, Tokyo (JP); Goki Toshima, Tachikawa (JP)

(73) Assignee: RENESAS TECHNOLOGY CORP.

(21) Appl. No.: 12/750,773

(22) Filed: Mar. 31, 2010

(51) Int. Cl. G06F 13/00

(52) U.S. Cl. 345/531

(57) ABSTRACT

The display unit can reduce the electric power consumed by the process of calculating an adjustment coefficient for display data, as typified by gradient control, and it can be readily adapted even to a display panel with a higher resolution. The display unit includes: a plurality of driving units arrayed in parallel and each operable to output a drive signal to a display panel; a plurality of first calculation units, and a plurality of display RAMs, each paired with one first calculation unit, the pairs of the first calculation units and display RAMs laid out along a direction of the parallel array of the driving units; and a second calculation unit which distributes display data supplied from outside to the display RAMs, receives display data from the display RAMs in parallel to analyze a histogram of tone distribution of pixel data corresponding to one screen, and calculates the adjustment coefficient based on a result of the analysis. In the display unit, the adjustment coefficient thus calculated is sent back to the first calculation units. The first calculation unit performs a calculation using display data read from the corresponding display RAM and the adjustment coefficient thereby to create drive data for the display panel.

### FIELD OF THE INVENTION

The present invention relates to a display driver which performs drive control of a display panel, and a display unit having a display panel and a display driver. Particularly, it relates to a technique useful in application to e.g. a display driver used for drive control of an LC display of a mobile device. Now, it is noted that LC stands for “Liquid Crystal”.

### BACKGROUND OF THE INVENTION

In regard to mobile devices typified by mobile phones and display devices as incorporated in television receivers of large size, the need for enhancement of image quality has been growing, and a signal-processing technique developed in step with the enhancement of image quality for serving such need is implemented on control processors and display drivers.

However, in regard to mobile devices and television receivers of large size, and display devices mounted thereon, and peripheral circuits for driving such display devices or performing the display control thereof, there is still much need for the decrease in power consumption because it is indispensable to reduce the load on the environment.

Japanese Published Patent Application No. JP-A-11-65531 discloses an image display unit which contributes to the reduction in power consumption by performing the control which includes the step of: adjusting image data to increase the transmission of an LC screen as far as possible; and accordingly decreasing the amount of light emission of a backlight.

On the other hand, Japanese Published Patent Application No. JP-A-2004-45865 discloses a display system, whose display quality is improved by taking a procedure which includes: splitting an LC panel into areas; providing a driver for each split area; and in the preceding stage, computing the mean of luminance of the whole screen and the mean of luminance of each split area to calculate adjustment data for control of luminance, and providing a result of the calculation to the driver for each split area.

### SUMMARY OF THE INVENTION

The image display unit as described in JP-A-11-65531 analyzes display data input from the control processor, and adjusts image data based on the result thereof. Therefore, the amount of image data targeted for the adjustment by such display unit increases four times or more in terms of QVGA ratios as the resolution of a display panel becomes higher, e.g. in the case of display panels for mobile devices, the standard shifts to WVGA. As a result, coping with such increase by increasing the operation frequency of the signal-processing unit operable to analyze and adjust display data raises the power consumption four times or more, and it becomes necessary to adapt processors to a high-speed operation. In addition, in the case of outputting luminance adjustment data for each split area as described in JP-A-2004-45865, it is required to calculate the mean of luminance of the whole screen and other factors, and therefore the conditions are the same.

Therefore, it is an object of the invention to provide a display driver which allows the reduction in power consumption involved in a calculation process of an adjustment coefficient for adjustment of display data as typified by luminance (gradient) adjustment, and which is easier to adapt to a higher resolution of a display panel.

It is another object of the invention to provide a display unit which allows the reduction in power consumption involved in a calculation process of an adjustment coefficient for adjustment of display data as typified by luminance (gradient) adjustment, and which is easier to adapt to a higher resolution of a display panel.

The above and other objects of the invention and novel features thereof will become clear from the description hereof and the accompanying drawings.

Of embodiments of the invention herein disclosed, a representative embodiment will be briefly described below in outline.

According to the embodiment, the display unit includes: a plurality of driving units arrayed in parallel and each operable to output a drive signal to a display panel; a plurality of first calculation units; and a plurality of display RAMs, each paired with one first calculation unit, the pairs of the first calculation units and display RAMs laid out along a direction of the parallel array of the driving units; and a second calculation unit which distributes display data supplied from outside among the display RAMs, receives display data from the display RAMs in parallel to analyze a histogram of tone distribution of pixel data corresponding to one screen, and calculates an adjustment coefficient for adjusting display data based on a result of the analysis. In the display unit, the second calculation unit sends the adjustment coefficient thus calculated back to each first calculation unit, and the first calculation units each perform a calculation using display data read from the corresponding display RAM, and the adjustment coefficient thereby to create drive data for the display panel.

According to the arrangement, the second calculation unit receives, in parallel, display data output from the display RAMs partitioned and allocated, each corresponding to an area of a display panel, and calculates an adjustment coefficient. Therefore, a display driver can be readily adapted even to a display panel with a higher resolution by enhancement of the parallel computing power of the second calculation unit, without increasing the operation frequency of the second calculation unit. Further, with display data targeted for the calculation using the adjustment coefficient, the first calculation units can read such display data from the corresponding display RAMs partitioned and allocated, for each display panel area. Therefore, the data path between each display RAM and the corresponding first calculation unit, and the data path of drive data between each first calculation unit and the corresponding driving unit can be both shortened. In this respect, the arrangement as described above is suitable to meet the requirement that a display driver should be disposed along a long side of a display panel. Still further, as the first calculation units each paired with one display RAM are arrayed in parallel, the data path between each display RAM and the corresponding first calculation unit may remain shortened even at the time of calculating an adjustment coefficient, and therefore the effect of reducing the bus activation power involved with data transfer, which is achieved by the shortened data path, is never counteracted. Further, the drive data sent from each first calculation unit to the corresponding driving unit needs to have a significant logical value on a proper number of bits. However, data to be transmitted from each display RAM to the second calculation unit needs to be significant just regarding the number of bits required for creation of a histogram and calculation of an adjustment coefficient, and for example, the logical values of low-order several bits may be fixed. The power consumption involved in data transfer between each display RAMs and the second calculation unit can be also reduced by so doing.

The effects achieved by the representative embodiment is as follows in brief.

The first is the power consumption involved in a calculation process of an adjustment coefficient for adjustment of display data as typified by luminance (gradient) adjustment can be reduced. The second is the adaptation to the higher resolution of a display panel becomes easier.

### BRIEF DESCRIPTION OF THE DRAWINGS

FIG. 1 is a block diagram showing an example of a display driver according to an embodiment of the invention;

FIG. 2A is a block diagram showing examples of interior arrangements of the master calculation unit and data calculation unit;

FIG. 2B is a table showing an example of the relation between an input and output of the low-order-n-bits-fixing subunit for each set value;

FIG. 3 is a block diagram showing an example of the display driver operable to control a backlight of the LC panel based on an amount of adjustment of display data;

FIG. 4A is a block diagram showing examples of the master calculation unit of the backlight control unit and the data calculation unit in detail;

FIG. 4B is a table showing an example of the correspondence between a value of select data and a select signal;

FIG. 5 is a block diagram showing an example of a display system, in which the power consumption developed in a data bus between a timing controller and each LC driver is reduced under the condition that a plurality of LC drivers are provided for one display panel, and the timing controller composed of an LSI operable to generate a signal for controlling the LC panel in display is used to adjust display data; and

FIG. 6 is a block diagram showing, as a modification of the example shown by FIG. 5, a system arranged on condition that a plurality of LC drivers must be provided because of the increase in the size and resolution of a display panel, in which the functions of a timing controller and a master calculation unit are gathered in one driver.

### DETAILED DESCRIPTION OF THE PREFERRED EMBODIMENTS

### 1. Outline

The preferred embodiments of the invention herein disclosed will be outlined first. Here, the reference numerals and signs for reference to the drawings, which are accompanied with paired round brackets, only exemplify what the concepts of components or elements referred to by the numerals, and signs contain.

[1] A display driver (102) in association with the invention has a plurality of driving units (117-120) arrayed in parallel and each operable to output a drive signal for a corresponding area of a display panel (101) according to tones based on drive data. The display driver has: a plurality of first calculation units (107-110); and a plurality of display RAMs (111-114), each paired with one first calculation unit, the pairs of the first calculation units and display RAMs laid out along a direction of the parallel array of the driving units; a display RAM control unit (115) which receives display data from outside and distributes the display data to the display RAMs; and a second calculation unit (106) which receives, in parallel, display data stored in the display RAMs, analyzes a histogram of tone distribution of pixel data corresponding to one screen, calculates an adjustment coefficient for adjusting display data based on a result of the analysis, and supplies the adjustment coefficient to each first calculation unit. The first calculation unit performs control to supply the second calculation unit with display data read from the corresponding display RAM, conducts a calculation using an adjustment coefficient supplied from the second calculation unit and display data read from the corresponding display RAM, and supplies the drive data to the corresponding driving unit.

According to the arrangement, the second calculation unit receives, in parallel, display data output from the display RAMs partitioned and allocated, and each corresponding to an area of a display panel, and calculates an adjustment coefficient. Therefore, a display driver can be readily adapted even to a display panel with a higher resolution by enhancement of the parallel computing power of the second calculation unit, without increasing the operation frequency of the second calculation unit. Further, with display data targeted for the calculation using the adjustment coefficient, the first calculation units can read such display data from the corresponding display RAMs partitioned and allocated, for each display panel area. Therefore, the data path between each display RAM and the corresponding first calculation unit, and the data path of drive data between each first calculation unit and the corresponding driving unit can be both shortened. In this respect, the arrangement as described above is suitable to meet the requirement that a display driver should be disposed along a long side of a display panel. Still further, as the first calculation units each paired with one display RAM are arrayed in parallel, the data path between each display RAM and the corresponding first calculation unit may remain shortened even at the time of calculating an adjustment coefficient, and therefore the effect of reducing the bus activation power involved with data transfer, which is achieved by the shortened data path, is never counteracted.

[2] In the display driver as described in [1], the display RAM control unit performs control to store display data supplied from outside in the display RAMs based on a destination address provided from outside. According to the arrangement, the receipt of only data difference between frames from outside will suffice for e.g. a still image.

[3] In the display driver as described in [1], the first calculation units each perform control to fix a predetermined number of low-order bits of display data to be supplied to the second calculation unit at one of logical values of one (1) and zero (0).

The drive data sent from each first calculation unit to the corresponding driving unit needs to have a significant logical value on a proper number of bits. However, data to be transmitted from each display RAM to the second calculation unit needs to be significant just regarding the number of bits required for creation of a histogram and calculation of an adjustment coefficient. Therefore, the power consumption involved with data transfer from each display RAM to the second calculation unit can be also reduced by fixing the logical values of low-order several bits.

[4] The display driver as described in [3] further includes a register on which values of the predetermined number of low-order bits can be set from outside by means of a software program. According to the arrangement, it becomes possible to selectively use adjustment coefficients according to required display accuracy.

[5] In the display driver as described in [3], the second calculation unit provides a set of random numbers to the predetermined number of low-order bits of display data supplied from each first calculation unit, and having logical values fixed, and calculates an adjustment coefficient for the display data provided with the set of random numbers. According to the arrangement, the adjustment coefficient can be prevented from being biased toward one side unlike the case of determining the adjustment coefficient while keeping fixed values of the low-order bits.

[6] In the display driver as described in [5], the calculation of the adjustment coefficient includes: determining a tone number at a point where a tone frequency of the tone distribution reaches a predetermined percentage below a tail of the tone distribution histogram on a high-luminance side thereof; and substituting a ratio of a maximum tone number to the tone number thus determined for the adjustment coefficient.

[7] In the display driver as described in [6], each first calculation unit multiplies display data read from the corresponding display RAM by the adjustment coefficient, and outputs a result of the multiplication as drive data, except a result of the multiplication for a tone number over the maximum tone number.

[8] The display driver as described in [7] further includes a backlight driving unit (305, 306) operable to produce a drive voltage to be supplied to a backlight of the display panel. The second calculation unit issues a direction for setting a dimming rate containing a reciprocal of the adjustment coefficient to the backlight driving unit. With the arrangement, the tones of an image data can be shifted toward the high-luminance side, and therefore the amount of light emission of the backlight can be reduced accordingly.

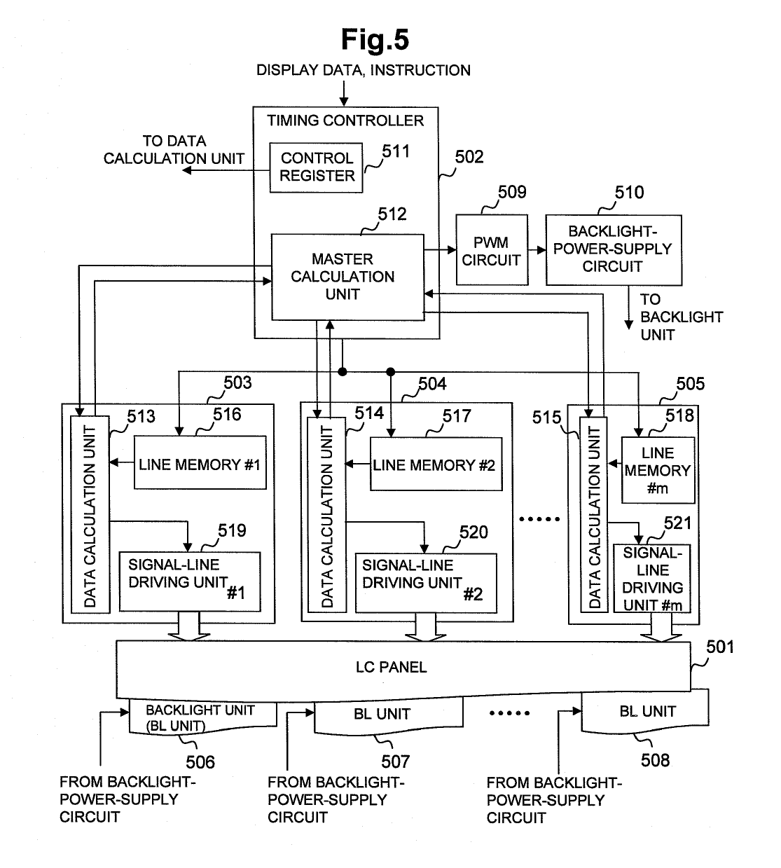

Also, in this respect, the invention can contribute to the reduction in power consumption.

[9] A display unit (FIG. 5) in connection with the invention has: a display panel (501); a plurality of backlight units (506-508) disposed corresponding to areas which the display panel divided into; a plurality of display driving units (503-505) disposed in a one-to-one correspondence with the backlight units; a controller (502) operable to control the plurality of display driving units; and a backlight driving unit (509, 510) operable to drive the backlight units. The display driving units each have: a signal-line driving unit (519-521) operable to output a drive signal to corresponding one of the areas which the display panel divided into according to tones based on drive data; a first calculation unit (513-515) disposed corresponding to the signal-line driving unit; and a display RAM (516-518). The controller performs control to distribute display data supplied from outside among the plurality of display RAMs, receives display data stored in the display RAMs in parallel to analyze a histogram of tone distribution of pixel data corresponding to one screen, and calculates an adjustment coefficient for adjusting display data based on a result of the analysis. The first calculation units each perform control to provide the controller with display data read from the corresponding display RAM, perform a calculation using an adjustment coefficient supplied from the controller and display data read from the corresponding display RAM, and supply the drive data to the corresponding signal-line driving unit.

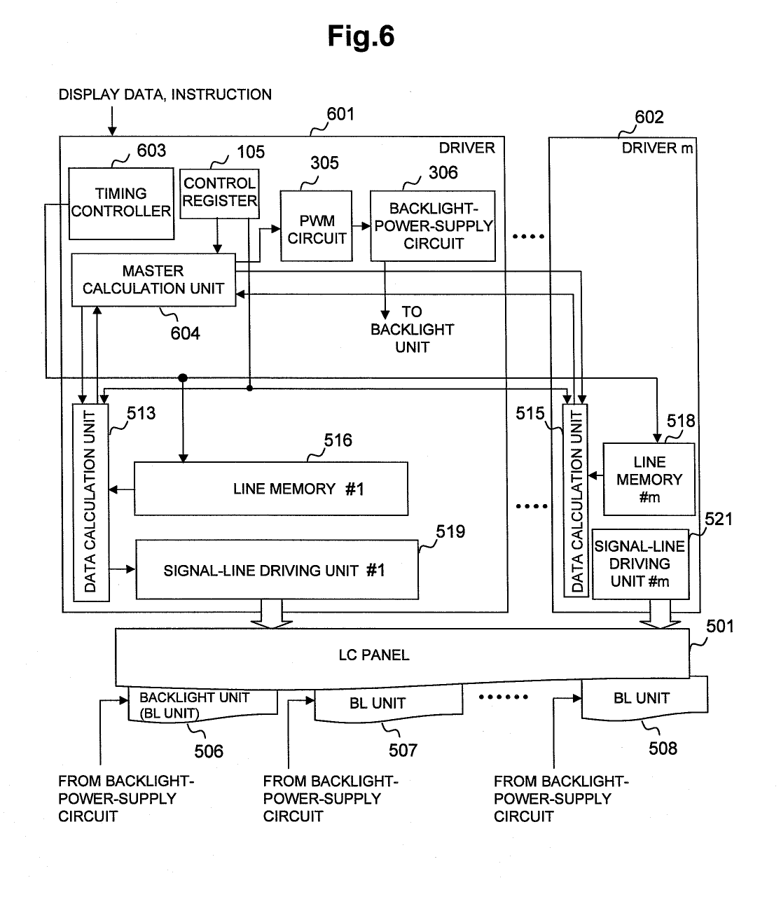

According to the arrangement, the reduction in power consumption as already described above can be achieved even with a display unit having a plurality of backlight units disposed in a one-to-one correspondence with areas which an LC panel is divided into. In addition, the arrangement as described above is suitable to meet the requirement that a display driver should be disposed along a long side of a display panel.

[10] In the display unit as described in [9], the first calculation units each perform control to fix a predetermined number of low-order bits of display data to be supplied to the controller at one of logical values of one (1) and zero (0).

[11] The display unit as described in [10] further includes a register on which values of the predetermined number of low-order bits can be set from outside by means of a software program.

[12] In the display unit as described in [10], the controller provides a set of random numbers to the predetermined number of low-order bits of display data supplied from each first calculation unit, and having logical values fixed, and calculates an adjustment coefficient for the display data provided with the set of random numbers.

[13] In the display unit as described in [12], the calculation of the adjustment coefficient includes: determining a tone number at a point where a tone frequency of the tone distribution reaches a predetermined percentage below a tail of the tone distribution histogram on a high-luminance side thereof; and substituting a ratio of a maximum tone number to the tone number thus determined for the adjustment coefficient.

[14] In the display unit as described in [13], each first calculation unit multiplies display data read from the corresponding display RAM by the adjustment coefficient, and outputs a result of the multiplication as drive data, except a result of the multiplication for a tone number over the maximum tone number.

[15] In the display unit as described in [14], the controller issues a direction for setting a dimming rate corresponding to a reciprocal of the adjustment coefficient to the backlight driving unit.

[16] A display unit (FIG. 6) from another aspect of the invention includes: a display panel (501); a plurality of backlight units (506-508) disposed corresponding to areas which the display panel divided into; and a plurality of display driving units (601-602) disposed in a one-to-one correspondence with the backlight units. Of the display driving units, one display driving unit (601) has a controller operable to control the display driving units (105, 603, 604); and a backlight driving unit (305, 306) operable to drive the backlight units. The display driving unit has a signal-line driving unit (519-521) operable to output a drive signal to corresponding one of the areas which the display panel divided into according to tones based on drive data; a first calculation unit (513-515) disposed corresponding to the signal-line driving unit; and a display RAM (516-518). The controller performs control to distribute display data supplied from outside among the plurality of the display RAMs, receives display data stored in the display RAMs in parallel to analyze a histogram of tone distribution of pixel data corresponding to one screen, and calculates an adjustment coefficient for adjusting display data based on a result of the analysis. The first calculation unit performs control to provide the controller with display data read from the corresponding display RAM, and performs a calculation using an adjustment coefficient supplied from the controller and display data read from the corresponding display RAM, and supplies the drive data to the corresponding signal-line driving unit.

According to the arrangement, the reduction in power consumption as already described above can be achieved even with a display unit having a plurality of backlight units disposed in a one-to-one correspondence with areas which an LC panel is divided into. In addition, the arrangement as described above is suitable to meet the requirement that a display driver should be disposed along a long side of a display panel.

[17] In the display unit as described in [16], the first calculation units each perform control to fix a predetermined number of low-order bits of display data to be supplied to the corresponding driving unit at one of logical values of one (1) and zero (0).

[18] The display unit as described in [17] further includes a register on which values of the predetermined number of low-order bits can be set from outside by means of a software program.

[19] In the display unit as described in [17], the controller provides a set of random numbers to the predetermined number of low-order bits of display data supplied from each first calculation unit, and having logical values fixed, and calculates an adjustment coefficient for the display data provided with the set of random numbers.

[20] In the display unit as described in [19], the calculation of the adjustment coefficient includes: determining a tone number at a point where a tone frequency of the tone distribution reaches a predetermined percentage below a tail of the tone distribution histogram on a high-luminance side thereof; and substituting a ratio of a maximum tone number to the tone number thus determined for the adjustment coefficient.

[21] In the display unit as described in [20], each first calculation unit multiplies display data read from the corresponding display RAM by the adjustment coefficient, and outputs a result of the multiplication as drive data, except a result of the multiplication for a tone number over the maximum tone number.

[22] In the display unit as described in [21], the controller issues a direction for setting a dimming rate corresponding to a reciprocal of the adjustment coefficient to the backlight driving unit.

### 2. Further Detailed Description of the Preferred Embodiments

Next, the preferred embodiments will be described further in detail.

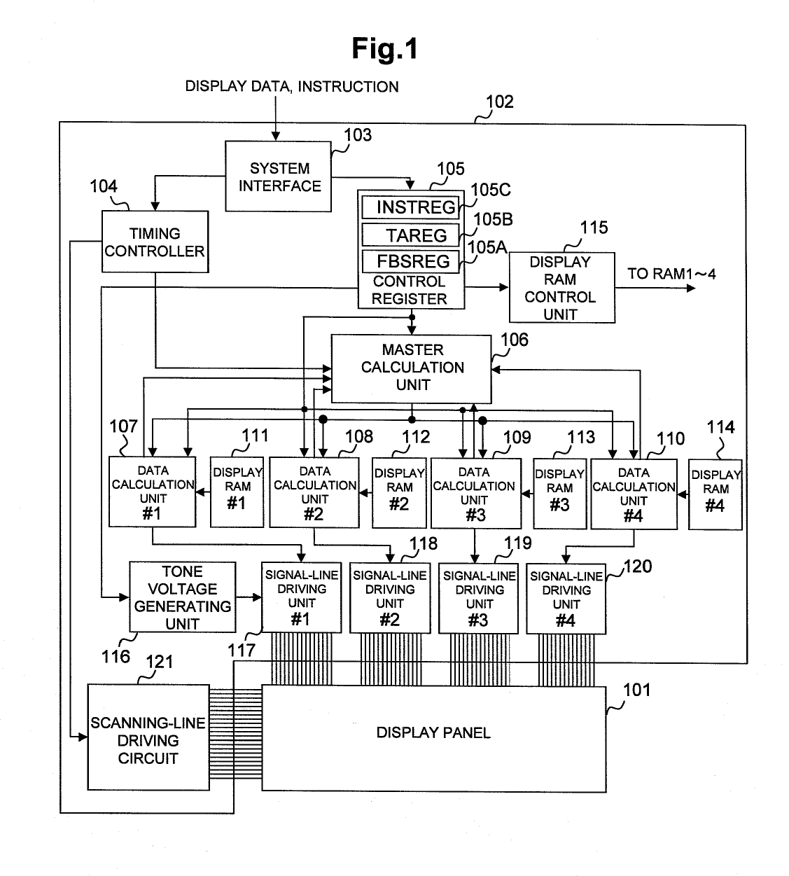

FIG. 1 shows an example of a display driver according to an embodiment of the invention. The display driver 102 of FIG. 1 receives an instruction, such as a display command, and display data from CPU (Central Processing Unit) or the like (not shown), and controls the display and driving of a display panel 101. In regard to the display driver 102, the reference numeral 103 denotes a system interface, 104 denotes a timing controller, 105 denotes a control register, 106 denotes a master calculation unit, 107 to 110 each denote a data calculation unit, 111 to 114 each denote a display RAM, 115 denotes a display RAM control unit, 116 denotes a tone voltage generating unit, 117 to 120 each denote a signal-line driving unit, and 121 denotes a scanning-line driving circuit.

The display panel 101 is e.g. a panel of a type controlled in its display luminance by the value of a voltage which the display driver 102 applies thereto, and it has signal and scanning lines arranged to form a matrix structure. Although no special restriction is intended, the display gradation of the display panel 101 is based on e.g. 256 tones labeled with tone numbers #0 to #255.

In the display driver 102, the scanning-line driving circuit 121 applies a scan pulse to scanning lines of the display panel 101 thereby to bring the lines to the select state thereof in turn, i.e. in the order of the lines aligning, and in synchronism with this, the signal-line driving units 117 to 120 apply tone voltages for controlling the display gradation to electrodes of pixels laid out in a matrix form through signal lines. The tone voltages applied to the pixel electrodes change the one-frame-period effective values of the pixels, whereby display luminance is controlled.

The system interface 103 receives display data and an instruction transferred from CPU, and outputs to the control register 105. Now, it is noted that the instruction is a piece of information for deciding an internal action of the display driver 102, which includes various parameters, such as a frame frequency, the number of lines to be driven, the number of colors, and the number of bits of a fixed value for later describing details of transfer data.

The control register 105 has control registers including: fixed-value-bit-number-setting register (FBSREG) 105A for holding information of the number of bits of a fixed value of transfer data received through the system interface 103; a destination address register (TAREG) 105B for specifying destination addresses, i.e. addresses of horizontal and vertical directions at the start of transmission, and addresses of horizontal and vertical directions at the end of transmission, in the display RAMs 111 to 114; and an instruction register (INSTREG) 105C. The display driver follows an instruction loaded into the instruction register 105C to generate an internal control signal, in which a value set in the register 105A is supplied to the master calculation unit 106, and a value set in the register 105B is fed to the display RAM control unit 115; an action of each unit of the display driver is controlled according to these values.

Display data is supplied to the display RAM control unit 115. Then the display RAM control unit 115 transfers the display data, inside the driver, to the display RAMs 111 to 114 according to addresses set in the register 105B. Specifically, when the display RAM control unit 115 transmits toward the display panel 101, the display data will be transferred from an upper left corner thereof in the horizontal direction in turn, distributed to the four display RAMs 111, 112, 113 and 114 and stored therein. In transmission of display data from CPU, only a changed portion of the data from the preceding frame is transferred, and therefore the control is conducted so that the display data is stored in an address region corresponding to the change in the display RAMs 111 to 114. The address for a changed portion of display data from the preceding frame has been set in advance in the destination address register (TAREG) 105B, and it will be supplied to the display RAM control unit 115 from there.

The timing controller 104 has a dot counter, and counts a dot clock—not shown in the drawing—supplied from the outside of the display driver 102 thereby to generate a line clock (horizontal synchronizing clock). The line clock determines the timing of data transfer to the master calculation unit 106 from the data calculation units 107 to 110, which are to be described later.

The display RAMs 111 to 114 have a storage capacity containing one frame in total, in which display data transferred from the display RAM control unit 115 are accumulated. Such arrangement allows the display driver 102 to have display control in displaying a still image if the data calculation units 107 to 110 read display data from the display RAMs 111 to 114 on an as-needed basis. As a result, it becomes unnecessary for the display driver 102 to constantly receive display data from CPU in synchronism with the timing of display, and data transfer from CPU to the display driver 102 can be suspended. Further, in the case of displaying a moving picture, it is sufficient to transfer, from CPU to the display driver, only a changed portion of display data from the preceding frame, as described above. Therefore, the power required for data transfer can be reduced. With this example, it is assumed that the display driver is provided with four display RAMs 111 to 114, and the four display RAMs 111 to 114 each store data corresponding to a quarter of one frame.

The data calculation unit 107 (108, 109, 110) reads display data from the display RAM 111 (112, 113, 114), substitutes data having fixed values in low-order n bits for the display data according to the number n of fixed-value bits transferred from the control register 105, and transmits the resulting data to the master calculation unit 106. The master calculation unit 106 uses the data so supplied to compute a data-adjustment coefficient, which is to be described later, and returns it to the data calculation unit 107 (108, 109, 110). The data calculation unit 107 (108,109,110) again reads display data from the display RAM 111 (112, 113, 114), adjusts the display data thus read based on the data-adjustment coefficient transmitted from the master calculation unit 106, and transfers the data to the signal-line driving unit 117 (118, 119, 120), which is to be described later.

The master calculation unit 106 performs a histogram analysis on input data from the data calculation units 107 to 110. Then, the master calculation unit 106 calculates an amount of adjustment of display data, namely a data-adjustment coefficient, based on the characteristic data resulting from the histogram analysis. The data-adjustment coefficient thus calculated is thereafter transmitted to the data calculation units 107 to 110. While a concrete example of the amount of adjustment is to be described later, it is used for e.g. control of data gradient decompression and backlight luminance reduction, and contrast decompression control. The histogram data thus acquired will be reset in synchronism with a vertical synchronizing signal Vsync input from the timing controller. In short, the histogram data are formed in display frames.

The tone voltage generating unit 116 generates, with respect to a source voltage VDH set from the outside, analog tone voltage levels for performing display in more than one tone by means of e.g. division of resistance. The analog tone voltage levels are input to the signal-line driving units 117 to 120, which are to be described later.

The signal-line driving unit 117, 118, 119 and 120 each include a level shifter, a selector circuit, and a buffer circuit for applying tone voltage to a signal line of the display panel 101. The internal action of the signal-line driving unit will be described below in detail. The level shifter converts digital display data transmitted from the data calculation unit 107 (108, 109, 110) into an operation voltage for the selector circuit lying in its subsequent stage. The selector circuit serves as a DA converter, and specifically it uses the display data subjected to conversion in voltage level to select one level from among analog tone voltages input from the tone voltage generating unit 116. The analog tone voltage thus selected is passed to the buffer circuit, and thereafter applied to the electrode of a pixel in the display panel 101. In this way, the display panel is controlled in display luminance.

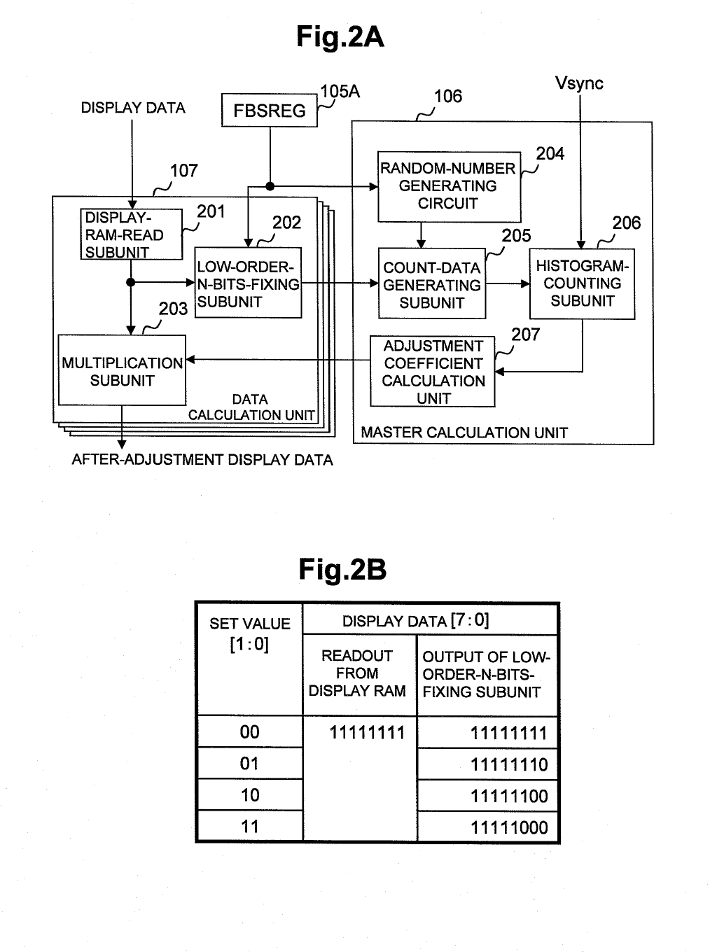

FIG. 2A shows examples of interior arrangements of the master calculation unit 106 and data calculation unit 107 (108, 109, 110). The reference numeral 201 denotes a display-RAM-read subunit, 202 denotes a low-order-n-bits-fixing subunit, 203 denotes a multiplication subunit, 204 denotes a random-number generating circuit, 205 denotes a count-data generating subunit, 206 denotes a histogram-counting subunit, and 207 denotes an adjustment-coefficient calculation subunit.

First, the display-RAM-read subunit 201 reads display data from the display RAM 111 (112, 113, 114) and transfers the data to the low-order-n-bits-fixing subunit. Then, the low-order-n-bits-fixing subunit 202 sets low-order n bits of the display data to a logical value of zero (0), i.e. Low level, according to a set value of the fixed-value-bit-number-setting register (FBSREG) 105A in the control register 105. FIG. 2B shows an example of the relation between an input and an output of the low-order-n-bits-fixing subunit 202 for each set value. First, in the case of the set value taking 2′b00, the step of forcefully fixing the low bits at the logical value 0 shall not be executed when the input, which is a readout from the display RAM, is e.g. 8′b11111111. Further, in the case of the set value taking 2′b01, data with the least significant bit fixed at the logical value 0 (Low level) shall be output in response to the input. As described above, the low-order-n-bits-fixing subunit 202 is arranged so that as the set value becomes larger, the number of low bits, namely the width of low bits, to be fixed at the logical value 0 (Low level) is larger. While the set value of the fixed-value-bit-number-setting register (FBSREG) 105A is made up of two bits here, it is not so limited. The number of bits forming the set value may be a number other than two.

On receipt of a set value of the fixed-value-bit-number-setting register (FBSREG) 105A included in the control register 105, the random-number generating circuit 204 generates a random number having a bit number depending on the number of bits of the set value, and transmits it to the count-data generating subunit 205. The random number is a pseudo-random number generated by e.g. method using LFSR (Linear Feedback Shift Register). However, the method of generating the random number is not limited to LFSR method, and another method may be used instead.

The count-data generating subunit 205 adds a random number of n bits transmitted from the random-number generating circuit 204 to the display data sent from the low-order-n-bits-fixing subunit 202, thereby to complement the width of missing bits, i.e. low-order n bits forcefully set to the fixed value 0, with the random number. The data complement is executed on the approximation that the width of missing bits exists with an equal probability.

The histogram-counting subunit 206 accepts the input of the vertical synchronizing signal Vsync from the timing controller 104, which determines the period of frames, and the input of display data from the count-data generating subunit 205. Then, the histogram-counting subunit 206 counts the display data to form a histogram. For example, data of the frequency distribution with respect to the number of pixels for each of the tone numbers #0 to #255 are created. The histogram-counting subunit 206 is controlled so that it is reset in synchronism with the vertical synchronizing signal Vsync, and therefore the histogram data are acquired in frames. The histogram-counting subunit 206 derives an appropriate select data value based on the histogram data so acquired. Taking an example of the deriving step, histogram-counting subunit 206 takes, as the select data value, the tone number at a point located 10 percent of the whole display data amount below the tail of the histogram distribution on the high-luminance side. The select data value thus acquired is transferred to the adjustment-coefficient-calculation unit 207.

In the case of supposing R, G and B color display data, each made up of eight bits, for example, the adjustment-coefficient-calculation unit 207 uses a select data value transmitted from the histogram-counting subunit 206 to carry out a calculation given by the following expression:

255÷4[Select Data Value].

Thus, a display-data-adjustment coefficient is calculated. If the tone number of the select data value is #250, for example, the display-data-adjustment coefficient is given by:

255÷250.

The multiplier 203 multiplies display data transmitted from the display-RAM-read subunit 201 by a display-data-adjustment coefficient transferred from the adjustment-coefficient-calculation unit 207. In this example, the display data are decompressed toward the high-luminance side by the multiplication. As a result, the luminance of the display data is shifted to the high-luminance side. In other words, the contrast is increased towards the high-luminance side. As a matter of course, part of display data over the tone number #255 is all incorporated in the data of the tone number #255.

Incidentally, the select data value may be the tone number at a point located 10 percent of the whole display data amount above the tail of the histogram distribution on the low-luminance side. For example, if the select data value is the tone number #5, the adjustment-coefficient-calculation unit 207 executes a calculation given by the following expression thereby to derive the display-data-adjustment coefficient:

255÷(255−Select Data Value).

Hence, on condition that the select data value is the tone number #5, the display-data-adjustment coefficient is derived from the calculation of 255÷250. Further, in this case, the multiplier 203 performs an arithmetic operation given by:

255−Adjustment Coefficient×(255−Display Data).

As a result, the luminance of the display data is shifted to the low-luminance side. In other words, the contrast is increased towards the low-luminance side. As a matter of course, part of display data below the tone number #5 is all incorporated in the data of the tone number #0.

The effect and advantage achieved by the arrangement of the display driver 102 as described above are as follows.

(1) The voltage fluctuation on a bus during data transfer to the master calculation unit can be partly suppressed by setting low-order n bits of transfer data from the data calculation units 107 to 110 to the master calculation unit 106 to a fixed value. As a result, the power consumption by the data bus between the master calculation unit 106 and data calculation units 107 to 110 can be reduced. In the case of supposing R, G and B color display data, each made up of eight bits, for example, the current for data transfer can be reduced to the three-quarters thereof on average with a set value of 2′b10.

(2) In regard to display systems, a large amount of power is consumed owing transfer of display data from CPU. However, e.g. the one for mobile use is arranged to have a display driver with a display RAM incorporated therein, for the purpose of cutting the power for transfer of a still image. According to such arrangement, it is sufficient for CPU only to transfer display data of a pixel targeted for update, and a display driver can update the display by reading data from the display RAM incorporated therein. The display driver 102 is arranged based on this standpoint, and has display RAMs 111 to 114 incorporated therein. Particularly, such display RAMs 111 to 114 are distributed and allocated along a longer side of the display panel. As to display modules, it is strongly required in terms of designability, for example, to lay out a display driver within a narrow range like a frame border. To meet such requirement, a chip including a display driver must have a short side reduced in size. However, it is expected that the long side of such display driver chip is elongated because a display driver chip has as many output pins as the number depending on the resolution of a display panel. As a result, a display driver will take an extremely elongated chip form. Therefore, it becomes necessary to replace the display RAM with a plurality of smaller RAMs distributed and allocated. The arrangement of a plurality of display RAMs like this can eliminate the problem that the distance from the display RAM to each signal-line driving unit varies widely depending on the position of each drive pin on the display panel, and thus an undesired signal propagation delay is enlarged. If assuming such arrangement, the step of reading display data from display RAMs must be performed at the time of creating a histogram to calculate an adjustment coefficient, and the time of multiplying display data by the adjustment coefficient thus calculated, respectively. However, it is undesired to arrange, in a plurality of distributed places, the master calculation unit which creates a histogram in frames to calculate an adjustment coefficient. In this case, data calculation units 107 to 110 are disposed near the partitioned display RAMs 111 to 114, corresponding to the display RAMs respectively. Low-order n bits of data transferred from the data calculation units 107 to 110 to the master calculation unit which creates a histogram to calculate an adjustment coefficient in frames are set to a fixed value, whereby the power consumption is reduced. Thus, although the requirement for distribution and allocation of display RAMs is met, the reduction in power consumption can be achieved even in the case of adding the step of determining an adjustment coefficient from display data and then processing display data with the adjustment coefficient.

(3) As long as the master calculation unit 106 receives display data from the data calculation units 107 to 110 in parallel, and performs parallel calculation steps, it is unnecessary to change the operation speed of the master calculation unit 106 even if the display resolution of a display panel is increased manyfold. It becomes possible to cope with a tendency toward a higher resolution of the display panel 101 readily.

While in the above-described example, four data calculation units 107 to 110 are provided in a one-to-one correspondence with the display RAMs partitioned and allocated, the number of display RAMs substituted for the only RAM of a display driver is not so limited. It may be any number other than four, as long as it is more than one. Further, it is assumed in the above description that the width of n bits of data transferred from the data calculation units 107 to 110 to the master calculation unit 106, which are fixed at a value of 0 (Low level) or 1 (High level) can be set with a register. However, the width of n bits may be fixed at a predetermined value. In regard to the invention, it is also assumed in the above description that the display driver 102 has a built-in scanning-line driving circuit 121. However, the scanning-line driving circuit may be formed in a chip manufactured independently of the chip of the display driver 102, or incorporated in the display panel 101.

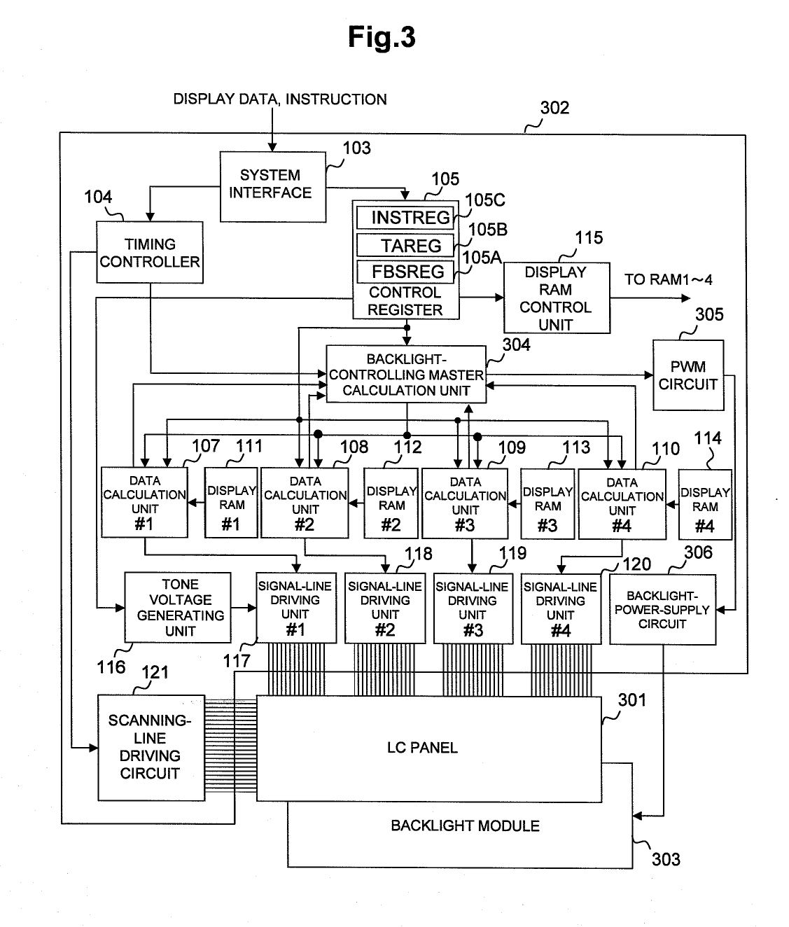

FIG. 3 shows an example of the display driver which can control a backlight of an LC panel based on an amount of adjustment of display data. In this example, an LC panel having as its indispensable part, a backlight makes a display panel. The reference numeral 301 denotes an LC panel, 302 denotes an LC driver, 303 denotes a backlight module, 304 denotes a backlight-controlling master calculation unit, 305 denotes a PWM circuit, and 306 denotes a backlight-power-supply circuit.

The LC panel 301 is controlled in its display luminance according to the level of a voltage applied by the LC driver 302. The LC panel 301 is e.g. a panel of an active matrix type, which has a plurality of pixels arrayed in a matrix form, a TFT provided for each pixel, and signal and scanning lines connected to the TFTs.

The LC driver 302 applies a scan pulse to the scanning lines in the LC panel 301 thereby to turn ON TFTs in turn, i.e. in the order of the lines aligning. Then, a tone voltage for controlling the display gradation is applied to an electrode of each pixel connected with a source terminal of TFT through the signal line. Now, it is noted that the tone voltage applied to the pixel electrode changes the effective value of a voltage provided to LC molecules, whereby the display luminance is controlled.

In regard to the backlight module 303, the amount of light emission thereof depends on the amount of current passing through light-emitting elements making up a backlight of the module. Whether to bring the action of light emission of the backlight to ON or OFF state is controlled by a pulse signal input from outside, e.g. the LC driver 302.

The backlight-controlling master calculation unit 304 is the same, in its basic action, as the master calculation unit 106 as shown in FIG. 1. However it is different in additionally having a signal generator for adjusting the luminance of light emission of the backlight module 303. The PWM circuit 305 modulates a backlight set value, which is transmitted from the backlight-controlling master calculation unit 304, into a pulse width. Specifically, the PWM circuit 305 uses a built-in counter thereof to count a dot clock transmitted from the timing controller 104, and uses its built-in comparator to compare a count value resulting from the counting with the backlight set value. Thus, a backlight control pulse which stays at High voltage for the duration of the clock equal to the backlight set value can be produced.

The backlight-power-supply circuit 306 has a built-in level shifter. The level shifter converts the backlight control pulse of a level between the source voltage (Vcc) and ground voltage (GND), which is transferred from the PWM circuit 305, to an operation voltage of the backlight module 303. After that, the backlight control pulse subjected to the voltage conversion is input to the backlight module 303, and the backlight is controlled in the amount of light emission according to display data.

Now, it is noted that in FIG. 3, circuit blocks having the same functions as those of the blocks shown in FIG. 1 are identified by the same reference numerals or signs, and their detailed descriptions are skipped here.

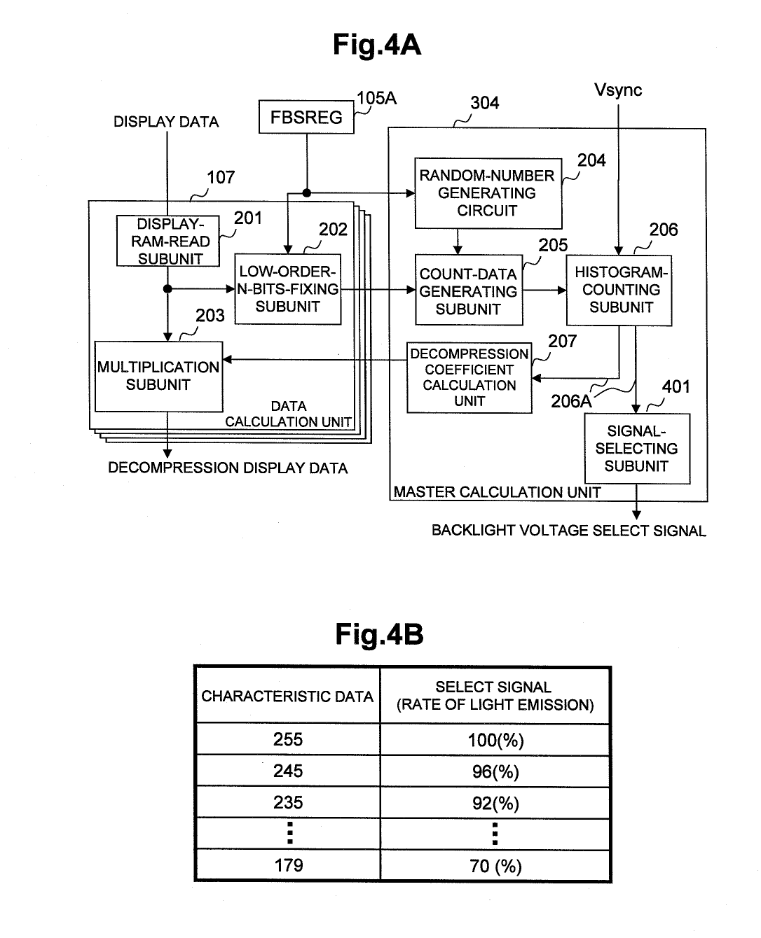

FIG. 4A shows examples of the backlight-controlling master calculation unit 304 and data calculation units 107 to 110 in more detail. In the drawing, the reference numeral 401 denotes a signal-selecting subunit. It is noted that in FIG. 4A, circuit blocks having the same functions as those of the blocks shown in FIG. 2A are identified by the same reference numerals or signs, and their detailed descriptions are skipped here.

The signal-selecting subunit 401 produces a select signal for selecting an integer showing an amount of light emission of the backlight based on a select data value 206A transmitted from the histogram-counting subunit 206. Incidentally, the select data value 206A is defined as e.g. the tone number at a point located 10 percent of the whole display data amount below the tail of the histogram distribution on the high-luminance side, as described above. A select signal corresponding to the select data value is produced using e.g. the table shown in FIG. 4B. The select signal corresponding to the select data value (characteristic data) 206A shows a rate of light emission. For example, in the case of the select data value of 235, the backlight set value is 92(%) because 235 divided by 255 is approximately equal to 92. The backlight set value selected by the signal-selecting subunit 401 is transmitted to the PWM circuit 305, and converted into a backlight control pulse there. Then, the resulting pulse will be used to control the amount of light emission of the backlight module 303 through the backlight-power-supply circuit 306.

Therefore, the display driver as shown in FIG. 3 can achieve the same effect as the display driver of FIG. 1. Further, the control for dimming the backlight is performed by a select signal depending on the reciprocal of an adjustment coefficient, which is a decompression coefficient, according to the decompression control of an image data, and therefore the power consumption by the backlight can be reduced.

While it has been presented above that the amount of light of the backlight module is controlled by the backlight control pulse, it may be controlled by an analog voltage level as long as the backlight module can be controlled likewise. In addition, while the example in which four data calculation units, substituted for a data calculation unit conventionally formed as one discrete structure, are provided has been described above, the number of the data calculation units is not so limited. It may be a number other than four as long as it is not less than two. Further, it has been described above that of data transferred from the data calculation unit to the master calculation unit, the width of n bits fixed at 0 (Low level) or 1 (High level) can be set using a register. However, the width of n bits may be a predetermined value. Moreover, the invention has been described on the assumption that the scanning-line driving circuit and power-supply circuit are incorporated in the LC driver, however the circuits may be formed in discrete chips respectively, or incorporated in an LC panel.

FIG. 5 shows an example of a display system, in which the power consumption developed in a data bus between a timing controller and each LC driver is reduced under the condition that a plurality of LC drivers are provided for one display panel, and the timing controller composed of an LSI operable to generate a signal for controlling the LC panel in display is used to adjust display data. Particularly, unlike the example described with reference to FIG. 1 arranged for control of the display on a mobile device typified by a mobile phone or the like, the example shown in FIG. 5 is arranged for control of display on a large screen such as a screen of a television receiver chiefly in consideration of display of a moving picture.

In the example of FIG. 5, the reference numeral 501 denotes an LC panel, 502 denotes a timing controller, 503 to 505 each denote an LC driver, 506 to 508 each denote a backlight unit, 509 denotes a PWM circuit, 510 denotes a backlight-power-supply circuit, 511 denotes a control register, 512 denotes a master calculation unit, 513 to 515 each denote a data calculation unit, 516 to 518 each denote a line memory, and 519 to 521 each denote a signal-line driving unit.

As in the example shown by FIG. 3, the LC panel 501 is a panel of an active matrix type having a screen size of e.g. inches or larger, and a resolution of XGA or higher. However, the LC panel is not limited to the size and resolution described here, but limited in size and resolution to meet the condition that a plurality of LC drivers 503 to 505 are provided in the panel, as already described.

As described above, the timing controller 502 is composed of a semiconductor LSI (Large Scale Integrated circuit) operable to generate a signal for controlling the LC panel 501 in display. The timing controller 502 has a dot counter, and counts a dot clock thereby to generate a line clock. Further, the timing controller 502 conducts a histogram analysis on display data for the purpose of data optimization.

The LC drivers 503 to 505 are formed in m chips which are identical in structure to each other. Each LC driver captures, from among display data input from the timing controller 502 for each horizontal line, only the display data corresponding to a signal line which the driver is responsible for. After adjustment of display data stored therein, the LC driver converts the data into an analog tone voltage, and applies the tone voltage to the signal line.

The backlight units 506 to 508 are provided so that each corresponds to one of two or more areas which the LC panel 501 is divided into, and are controlled in the luminance of light emission independently of one another.

The PWM circuit 509 is identical to that shown in FIG. 3 in its basic action. However, the PWM circuit 509 is different in having not one input-and-output system, but sets of input and output corresponding, in number, to the backlight units 506 to 508.

Like the PWM circuit 509, the backlight-power-supply circuit 510 is identical to the PWM circuit according to the second embodiment in its basic action. However, it is different in having not one input-and-output system, but sets of input and output corresponding, in number, to the backlight units 506 to 508 provided therein.

The control register 511 has a built-in latch circuit, and has a width-of-fixed-bits setting register operable to hold information of the width of bits of a fixed value in transfer data received from the outside.

The master calculation unit 512 is identical to the backlight-controlling master calculation unit 304 according to the second embodiment in basic structure. However, it is different in being incorporated in the timing controller 502 rather than being provided in the LC drivers 503 to 505. Therefore, the master calculation unit 512 counts data of a histogram on data transmitted from the data calculation units 513 to 515 incorporated in the LC drivers 503 to 505 respectively.

In creating a histogram, the number of pixels is counted for each tone number in turn, on image data supplied from a line memory in units of lines to create a histogram for each frame.

The data calculation units 513 to 515 are identical to the data calculation units 107 to 110 of the example shown in FIG. 3 in basic action. However, in comparison to the data calculation units in the example shown in FIG. 4A, the data calculation units 513 to 515 are different in that each LC driver 503 (504, 505) has one data calculation unit provided therein. Also, as described above, transfer data with low-order n bits replaced with a fixed value is transferred to the timing controller formed in a chip separate from the LC driver 503 (504, 505).

The line memories 516 to 518 are used for storing display data on the respective signal lines, and each have a region comparable, in capacity, to the data amount corresponding to two horizontal lines divided by the number m of the LC drivers. As this example is presumed on the display control on a television receiver or the like, the line memories never receive a difference of a still image as display data simply. Accordingly, the timing controller 502 never needs control such that a difference of display data is allocated according to a destination address as in the example described with reference to FIG. 1. Therefore, the display RAMs are also arranged as the line memories as described above.

The signal-line driving units 519 to 521 are identical to the signal-line driving units 117 to 120 shown in FIG. 1 in basic action. However, the example of FIG. 5 is different in that the signal-line driving units 519 to 521 are each placed in one LC driver 503 (504, 505).

The other circuit blocks shown in FIG. 5 are the same in structure as those in the examples of FIGS. 1 and 3, and therefore the detailed descriptions thereof are skipped here.

Next, the actions in the timing controller 502 and LC drivers 503 to 505 will be described.

Of data input to the timing controller 502 from the system, the information of the width of bits of a fixed value of transfer data is stored in the control register 511 and then transferred to the LC drivers 503 to 505. Pieces of the display data input from the system serially are transmitted to line memories 516 to 518 incorporated in the LC drivers 503 to 505 in turn; the line memories are comparable to two lines in total capacity. In this example, the data calculation units 513 to 515 read display data of the respective lines from the corresponding line memories, and prepare data with low-order n bits replaced with a fixed value based on the information of the width of bits of a fixed value stored in the control register 511. The data thus prepared are transmitted to the master calculation unit 512. The internal action of the master calculation unit 512 is the same as that of the backlight-controlling master calculation unit 304 in the example of FIG. 3. The master calculation unit 512 transmits a data decompression coefficient to the data calculation units 513 to 515, and a backlight set value to the PWM circuit 509.

According to the manner as described above, the following effect can be achieved by the arrangement as described with reference to FIG. 5, which is the same as the arrangement described with reference to FIG. 1 achieves. That is, even with the resolution (pixel number) of the LC panel 501 increased, the data processing capacity of the master calculation unit 512 can be adapted for it readily. In addition, low-order n bits of transfer data input to the timing controller 502 and LC drivers 503 to 505 are set to a fixed value, whereby the variation in voltage is suppressed. As a result, the power consumed in data buses between the timing controller 502 and LC drivers 503 to 505 can be reduced. In the case of supposing R, G and B color display data, each made up of eight bits and the set value of 2′b10, for example, the current for data transfer can be reduced to the three-quarters thereof on average.

While it has been described with this embodiment that the width of bits n to be fixed at 0 (Low level) or 1 (High level) of transfer data from the LC drivers to the timing controller can be set by a register, the width of bits n may be a predetermined value. In addition, the description concerning the invention has been presented on the assumption that the scanning-line driving circuit and power-supply circuit are incorporated in the LC driver. However, the scanning-line driving circuit and power-supply circuit may be formed in separate chips respectively, or incorporated in an LC panel.

FIG. 6 shows a modification of the example shown in FIG. 5. The example of FIG. 6 is arranged on condition that a plurality of LC drivers must be provided because of the increase in the size and resolution of a display panel, in which the timing controller, master calculation unit, etc. are gathered in one driver. Like the example of FIG. 5, the example of FIG. 6 is presumed on the display control on a large screen of a television receiver or the like, and arranged chiefly in consideration of display of a moving picture.

In regard to the example of FIG. 6, the reference numerals 601 and 602 denote a plurality of LC drivers, 603 denotes a timing controller, and 604 denotes a master calculation unit.

The number of LC drivers typified by the ones labeled with the numerals 601 and 602 is m. One of the LC drivers, labeled with 601, has therein a timing controller 603, a control register 105, a PWM circuit 305, a backlight-power-supply circuit 306 and a master calculation unit 604, like the driver as shown in FIG. 1, and it forms a master driver. However, other LC drivers typified by the LC driver 602, the number of which is m−1, have none of them, and each make a slave driver. All the LC drivers work in synchronism with a timing signal output by the timing controller 603 incorporated in the master LC driver 601. Incidentally, an LC driver having the same circuit structure as that of the master LC driver 601 may be adopted as the slave LC driver 602. However, in such case, operations of the timing controller, control register, PWM circuit, backlight-power-supply circuit, and master calculation unit of the slave LC driver 602 are inhibited.

The timing controller 603 is identical to the timing controller 502 as shown in example of FIG. 5 in basic action. However, it is different in that the timing controller is incorporated in the LC drivers 601 and 602.

The master calculation unit 604 is identical to the backlight-controlling master calculation unit 304 in the example of FIG. 3 in basic action. However, it is different in that data targeted for the histogram counting are input from the LC drivers 601 and 602.

Other functional blocks shown in FIG. 6 are the same as those in the example of FIG. 5, and therefore the descriptions thereof are skipped here.

Next, the actions of the LC drivers 601 and 602 will be described in detail. Of data input to the LC driver 601 from the system, the information of the width of bits of a fixed value of transfer data is first stored in the control register 105, and then transferred to the LC driver 602 set as a slave. Pieces of the display data input from the system serially are transmitted to the line memories 516 to 518 incorporated in the LC drivers 601 and 602 through the timing controller 603 in turn; the line memories are comparable to two lines in total capacity. In this example, the data calculation units 513 to 515 read display data of the respective lines from the corresponding line memories, and prepare data with low-order n bits replaced with a fixed value based on the information of the width of bits of a fixed value stored in the control register 511. The data thus prepared are transmitted to the master calculation unit 604. The internal action of the master calculation unit 604 is the same as that of the master calculation unit 512 in the example of FIG. 5. The master calculation unit 604 transmits a data decompression coefficient to the data calculation units 513 to 515, and a backlight set value to the PWM circuit 305.

According to the circuit arrangement and actions as described above, the following effect can be achieved. That is, even with the resolution of the LC panel 501 increased, the data processing capacity of the master calculation unit 604 can be adapted for it readily. In addition, low-order n bits of transfer data from the slave LC driver 602 to the master LC driver 601 are set to a fixed value, whereby the variation in voltage is suppressed. As a result, the power consumed in a data bus between the slave LC driver 602 and master LC driver 601 can be reduced. In the case of supposing R, G and B color display data, each made up of eight bits and the set value of 2′b10, for example, the current for data transfer can be reduced to the three-quarters thereof on average.

While it has been described with this embodiment that the width of bits n to be fixed at 0 (Low level) or 1 (High level) of transfer data from the slave LC driver to the master LC driver can be set by a register, the width of bits n may be a predetermined value. In addition, the description concerning the invention has been presented on the assumption that the scanning-line driving circuit and power-supply circuit are incorporated in the LC driver. However, the scanning-line driving circuit and power-supply circuit may be formed in separate chips respectively, or incorporated in an LC panel.

The invention made by the inventor has been concretely described above based on the embodiments. However, the invention is not limited to the embodiments. It is obvious that various changes and modifications may be made without departing from the scope of the invention. For instance, all the display RAMs which the display drivers have may contain one frame in capacity. Further, in the case of display control on a large screen, line memories corresponding to a plurality of scanning lines of one frame may be adopted.

The invention enables the materialization of the enhancement of the image quality, or backlight control with a reduced power consumption, which is based on the result of display data analysis, e.g. histogram analysis. The invention is applicable to a wide range from the drive control of displays for mobile devices to the drive control of displays for television receivers of large size.

What is claimed is:

1. A display driver comprising:
a plurality of driving units arrayed in parallel and each operable to output a drive signal for a corresponding area of a display panel according to tones based on drive data;
a plurality of first calculation units;
a plurality of display RAMs, each paired with one first calculation unit, the pairs of the first calculation units and display RAMs laid out along a direction of the parallel array of the driving units;
a display RAM control unit operable to distribute display data supplied from outside to the plurality of the display RAMs; and
a second calculation unit operable to receive display data stored in the display RAMs in parallel, analyze a histogram of tone distribution of pixel data corresponding to one screen, calculate an adjustment coefficient for adjusting display data based on a result of the analysis, and supplies the adjustment coefficient to each first calculation unit,
wherein the first calculation unit performs control to supply the second calculation unit with display data read from the corresponding display RAM, conducts a calculation using the adjustment coefficient supplied from the second calculation unit and the display data read from the corresponding display RAM, and supplies the drive data to the corresponding driving unit.

2. The display driver according to claim 1, wherein the display RAM control unit performs control to store display data supplied from outside in the display RAMs based on a destination address provided from outside.

3. The display driver according to claim 1, wherein the first calculation units each perform control to fix a predetermined number of low-order bits of display data to be supplied to the second calculation unit at one of logical values of one and zero.

4. The display driver according to claim 3, further comprising a register on which values of the predetermined number of low-order bits can be set from outside by means of a software program.

5. The display driver according to claim 3, wherein the second calculation unit provides a set of random numbers to the predetermined number of low-order bits of display data supplied from each first calculation unit, and having logical values fixed, and calculates an adjustment coefficient for the display data provided with the set of random numbers.

6. The display driver according to claim 5, wherein the calculation of the adjustment coefficient includes: determining a tone number at a point where a tone frequency of the tone distribution reaches a predetermined percentage below a tail of the tone distribution histogram on a high-luminance side thereof; and substituting a ratio of a maximum tone number to the tone number thus determined for the adjustment coefficient.

7. The display driver according to claim 6, wherein each first calculation unit multiplies display data read from the corresponding display RAM by the adjustment coefficient, and outputs a result of the multiplication as drive data, except a result of the multiplication for a tone number over the maximum tone number.

8. The display driver according to claim 7, further comprising a backlight driving unit operable to produce a drive voltage to be supplied to a backlight of the display panel,
wherein the second calculation unit issues a direction for setting a dimming rate containing a reciprocal of the adjustment coefficient to the backlight driving unit.

9. A display unit comprising:
a display panel;
a plurality of backlight units disposed corresponding to areas which the display panel divided into;
a plurality of display driving units disposed in a one-to-one correspondence with the backlight units;
a controller operable to control the display driving units; and
a backlight driving unit operable to drive the backlight units,
wherein the display driving units each have
a signal-line driving unit operable to output a drive signal to corresponding one of the areas which the display panel divided into according to tones based on drive data,
a first calculation unit disposed corresponding to the signal-line driving unit, and
a display RAM,
the controller performs control to distribute display data supplied from outside among the plurality of the display RAMs, receive display data stored in the display RAMs in parallel to analyze a histogram of tone distribution of pixel data corresponding to one screen, and calculate an adjustment coefficient for adjusting display data based on a result of the analysis, and
the first calculation units each perform control to provide the controller with display data read from the corresponding display RAM, perform a calculation using an adjustment coefficient supplied from the controller and display data read from the corresponding display RAM, and supply the drive data to the corresponding signal-line driving unit.

10. The display unit according to claim 9, wherein the first calculation units each perform control to fix a predetermined number of low-order bits of display data to be supplied to the controller at one of logical values of one and zero.

11. The display unit according to claim 10, further comprising a register on which values of the predetermined number of low-order bits can be set from outside by means of a software program.

12. The display unit according to claim 10, wherein the controller provides a set of random numbers to the predetermined number of low-order bits of display data supplied from each first calculation unit, and having logical values fixed, and calculates an adjustment coefficient for the display data provided with the set of random numbers.

13. The display unit according to claim 12, wherein the calculation of the adjustment coefficient includes: determining a tone number at a point where a tone frequency of the tone distribution reaches a predetermined percentage below a tail of the tone distribution histogram on a high-luminance side thereof; and substituting a ratio of a maximum tone number to the tone number thus determined for the adjustment coefficient.

14. The display unit according to claim 13, wherein each first calculation unit multiplies display data read from the corresponding display RAM by the adjustment coefficient, and outputs a result of the multiplication as drive data, except a result of the multiplication for a tone number over the maximum tone number.

15. The display unit according to claim 14, wherein the controller issues a direction for setting a dimming rate containing a reciprocal of the adjustment coefficient to the backlight driving unit.

16. A display unit comprising:
a display panel;
a plurality of backlight units disposed corresponding to areas which the display panel divided into; and
a plurality of display driving units disposed in a one-to-one correspondence with the backlight units,
wherein one of the display driving units has a controller operable to control the plurality of the display driving units, and a backlight driving unit operable to drive the backlight units,
the display driving unit has
a signal-line driving unit operable to output a drive signal to corresponding one of the areas which the display panel divided into according to tones based on drive data,
a first calculation unit disposed corresponding to the signal-line driving unit; and
a display RAM,
the controller performs control to distribute display data supplied from outside among the plurality of the display RAMs, receives display data stored in the display RAMs in parallel to analyze a histogram of tone distribution of pixel data corresponding to one screen, and calculates an adjustment coefficient for adjusting display data based on a result of the analysis, and
the first calculation unit performs control to provide the controller with display data read from the corresponding display RAM, and performs a calculation using an adjustment coefficient supplied from the controller and display data read from the corresponding display RAM, and supplies the drive data to the corresponding signal-line driving unit.

17. The display unit according to claim 16, wherein the first calculation units each perform control to fix a predetermined number of low-order bits of display data to be supplied to the corresponding driving unit at one of logical values of one (1) and zero (0).

18. The display unit according to claim 17, further comprising a register on which values of the predetermined number of low-order bits can be set from outside by means of a software program.

19. The display unit according to claim 17, wherein the controller provides a set of random numbers to the predetermined number of low-order bits of display data supplied from each first calculation unit, and having logical values fixed, and calculates an adjustment coefficient for the display data provided with the set of random numbers.

20. The display unit according to claim 19, wherein the calculation of the adjustment coefficient includes: determining a tone number at a point where a tone frequency of the tone distribution reaches a predetermined percentage below a tail of the tone distribution histogram on a high-luminance side thereof, and substituting a ratio of a maximum tone number to the tone number thus determined for the adjustment coefficient.
